(19) United States
(12) Patent Application Publication
(10) Pub. No.: US 2025/0126564 A1
(43) Pub. Date: Apr. 17, 2025

(54) APPARATUS, SYSTEM, AND METHOD OF MULTI-LINK POWER MANAGEMENT

(71) Applicant: Laurent Cariou, Milizac (FR)

(72) Inventor: Laurent Cariou, Milizac (FR)

(21) Appl. No.: 19/002,595

(22) Filed: Dec. 26, 2024

Related U.S. Application Data
(60) Provisional application No. 63/627,599, filed on Jan. 31, 2024.

(51) Int. Cl. H04W 52/02; H04L 5/00

(52) U.S. Cl. CPC H04W 52/0235; H04L 5/0053; H04W 52/0216

(57) ABSTRACT

For example, a non Access Point (AP) (non-AP) Multi-Link Device (MLD) may process a multi-link processing delay value in a first frame from an AP MLD to identify a multi-link processing delay time for the AP MLD; transmit a second frame from a first non-AP station (STA) affiliated with the non-AP MLD to the AP MLD over a first link, the second frame including a multi-link power management field to change a power management mode for at least one second non-AP STA from a first power management mode to a second power management mode, wherein the at least one second non-AP STA is affiliated with the non-AP MLD and is operative over at least one second link with the AP MLD; and change the power management mode for the at least one second non-AP STA based on the multi-link processing delay time for the AP MLD.

### CROSS REFERENCE

This Application claims the benefit of and priority from U.S. Provisional Patent Application No. 63/627,599 entitled “CROSS LINK POWER SAVE WITH PROCESSING DELAY RULES”, filed Jan. 31, 2024, the entire disclosure of which is incorporated herein by reference.

### BACKGROUND

According to some wireless s communication protocols, a wireless communication station (STA) may be allowed to enter a power save mode, e.g., in order to reduce a power consumed by the STA.

According to some wireless communication protocols, the STA may be allowed to transmit a power-management indication to an Access Point (AP) to indicate to the AP that the STA is to transition between a first power mode and a second power mode.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of a multi-link communication scheme, which may be implemented in accordance with some demonstrative aspects.

FIG. 3 is a schematic illustration of a multi-link communication scheme, which may be implemented in accordance with some demonstrative aspects.

FIG. 4 is a schematic flow-chart illustration of a method of multi-link power management, in accordance with some demonstrative aspects.

FIG. 5 is a schematic flow-chart illustration of a method of multi-link power management, in accordance with some demonstrative aspects.

FIG. 6 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

The words “exemplary” and “demonstrative” are used herein to mean “serving as an example, instance, demonstration, or illustration”. Any aspect, or design described herein as “exemplary” or “demonstrative” is not necessarily to be construed as preferred or advantageous over other aspects, or designs.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [ . . . ], etc. The phrase “at least one of” with regard to a group of elements may be used herein to mean at least one element from the group consisting of the elements. For example, the phrase “at least one of” with regard to a group of elements may be used herein to mean one of the listed elements, a plurality of one of the listed elements, a plurality of individual listed elements, or a plurality of a multiple of individual listed elements.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications, December 2020); IEEE 802.11be (IEEE P802.11be/D5.0 Draft Standard for Information technology—Telecommunications and information exchange between systems Local and metropolitan area networks—Specific requirements; Part 11: Wireless LAN Medium Access Control (MAC) and Physical Layer (PHY) Specifications; Amendment 8: Enhancements for extremely high throughput (EHT), November 2023); and/or IEEE802.11bn (IEEE 802.11bn, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications-Amendment: Enhancements for Ultra High Reliability (UHR))) and/or future versions and/or derivatives thereof, devices and/or networks operating in accordance with existing cellular specifications and/or protocols, and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

The terms “processor” or “controller” may include, for example, any kind of technological entity that allows handling of any suitable type of data and/or information. The data and/or information may be handled according to one or more specific functions executed by the processor or controller. Further, a processor or a controller may be understood as any kind of circuitry, e.g., including any kind of analog and/or digital circuitry. A processor or a controller may be or may include analog circuitry, digital circuitry, mixed-signal circuitry, logic circuitry, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), one or more processor cores, a single-core processor, a dual-core processor, a multiple-core processor, a host processor, a chip, a microchip, one or more circuits, circuitry, a logic unit, an Integrated Circuit (IC), any other suitable multi-purpose or specific processor or controller, and the like, or any combination thereof. Any other kind of implementation of the respective functions, which will be described below in further detail, may also be understood as a processor, controller, or logic circuit. It is understood that any two (or more) processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “memory” may include, for example, any type of technological entity, for example, a storage medium, for example, a computer-readable medium (e.g., a non-transitory computer-readable medium), and/or any other suitable medium, in which data or information can be stored for retrieval. For example, references to “memory” may refer to volatile or non-volatile memory, including random access memory (RAM), read-only memory (ROM), dynamic RAM (DRAM), synchronous DRAM (SD-RAM), a flash memory, a volatile memory, a non-volatile memory, a cache memory, a buffer, a short term memory, a long term memory, among others, or any combination thereof. Registers, shift registers, processor registers, data buffers, among others, are also embraced herein by the term memory.

Some demonstrative aspects may be used in conjunction with a WLAN, e.g., a Wi-Fi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a sub-7 GHz frequency band, for example, a 2.4 GHz frequency band, a 5 GHz frequency band, a 6 GHz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 GHz and 300 GHz, for example, a frequency band above 40 GHz, for example, a frequency band above 45 GHz, e.g., a 60 GHz frequency band, a frequency band between 42.5 GHz and 71 GHz, and/or any other mmWave frequency band.

Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (SIG) band, a WLAN frequency band, a WPAN frequency band, and the like.

Some demonstrative aspects may be implemented by an mmWave STA (mSTA), which may include for example, a STA having a radio transmitter, which is capable of operating on a channel that is within the mmWave frequency band. In one example, mmWave communications may involve one or more directional links to communicate at a rate of multiple gigabits per second, for example, at least 1 Gigabit per second, e.g., at least 7 Gigabit per second, at least 30 Gigabit per second, or any other rate.

In some demonstrative aspects, the mmWave STA may include a Directional Multi-Gigabit (DMG) STA, which may be configured to communicate over a DMG frequency band. For example, the DMG band may include a frequency band wherein the channel starting frequency is above 45 GHz.

In some demonstrative aspects, the mm Wave STA may include an Enhanced DMG (EDMG) STA, which may be configured to implement one or more mechanisms, which may be configured to enable Single User (SU) and/or Multi-User (MU) communication of Downlink (DL) and/or Uplink frames (UL) using a MIMO scheme. For example, the EDMG STA may be configured to implement one or more channel bonding mechanisms, which may, for example, support communication over a channel bandwidth (BW) (also referred to as a “wide channel”, an “EDMG channel”, or a “bonded channel”) including two or more channels, e.g., two or more 2.16 GHz channels. For example, the channel bonding mechanisms may include, for example, a mechanism and/or an operation whereby two or more channels, e.g., 2.16 GHz channels, can be combined, e.g., for a higher bandwidth of packet transmission, for example, to enable achieving higher data rates, e.g., when compared to transmissions over a single channel. Some demonstrative aspects are described herein with respect to communication over a channel BW including two or more 2.16 GHz channels, however other aspects may be implemented with respect to communications over a channel bandwidth, e.g., a “wide” channel, including or formed by any other number of two or more channels, for example, an aggregated channel including an aggregation of two or more channels. For example, the EDMG STA may be configured to implement one or more channel bonding mechanisms, which may, for example, support an increased channel bandwidth, for example, a channel BW of 4.32 GHz, a channel BW of 6.48 GHz, a channel BW of 8.64 GHz, and/or any other additional or alternative channel BW. The EDMG STA may perform other additional or alternative functionality.

In other aspects, the mmWave STA may include any other type of STA and/or may perform other additional or alternative functionality. Other aspects may be implemented by any other apparatus, device and/or station.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

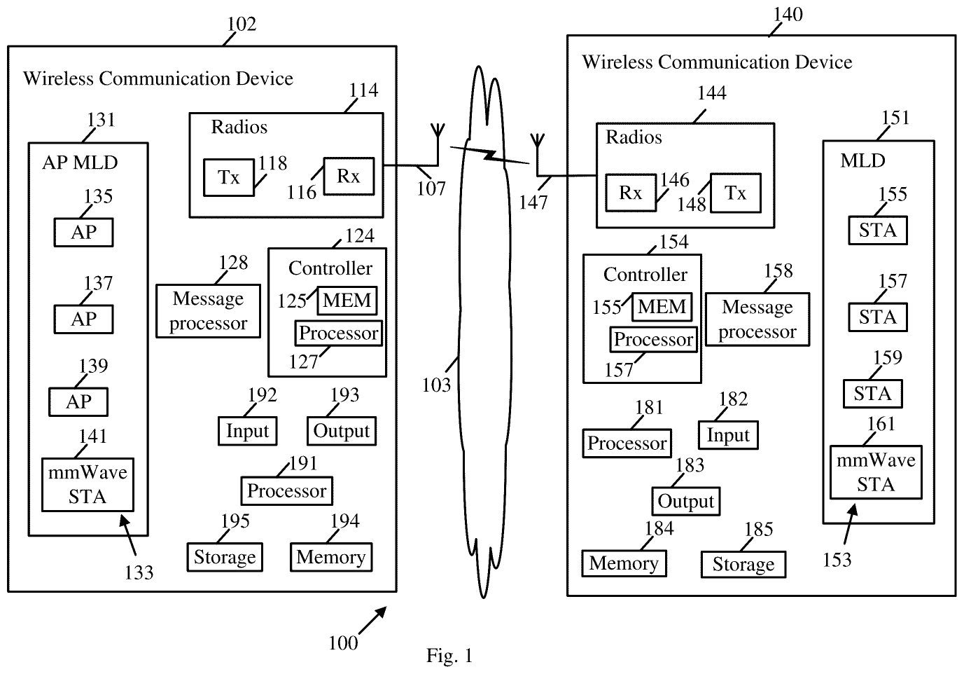

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, and/or one or more other devices.

In some demonstrative aspects, devices 102 and/or 140 may include a mobile device or a non-mobile, e.g., a static, device.

For example, devices 102, and/or 140 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player, or the like.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an Operating System (OS) of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a disk drive, a solid-state drive (SSD), and/or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102 and/or 140 may be capable of communicating content, data, information and/or signals via a wireless medium (WM) 103. In some demonstrative aspects, wireless medium 103 may include, for example, a radio channel, an RF channel, a Wi-Fi channel, a cellular channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10 GHz wireless communication frequency band, for example, one or more channels in a sub-7 GHz wireless communication frequency band, for example, one or more channels in a 2.4 GHz wireless communication frequency band, one or more channels in a 5 GHz wireless communication frequency band, and/or one or more channels in a 6 GHz wireless communication frequency band. For example, WM 103 may additionally or alternatively include one or more channels in an mm Wave wireless communication frequency band, for example, one or more channels in a frequency band above 40 GHz, for example, one or more channels in a frequency band above 45 GHz, e.g., one or more channels in a 60 GHz frequency band, one or more channels in a frequency band between 42.5 GHz and 71 GHz, and/or one or more channels in any other mmWave frequency band.

In other aspects, WM 103 may include any other type of channel over any other frequency band.

In some demonstrative aspects, device 102 and/or device 140 may include one or more radios including circuitry and/or logic to perform wireless communication between devices 102, 140, and/or one or more other wireless communication devices. For example, device 102 may include one or more radios 114, and/or device 140 may include one or more radios 144.

In some demonstrative aspects, radios 114 and/or 144 may include one or more wireless receivers (Rx) including circuitry and/or logic to receive wireless communication signals, RF signals, frames, blocks, transmission streams, packets, messages, data items, and/or data. For example, a radio 114 may include at least one receiver 116, and/or a radio 144 may include at least one receiver 146.

In some demonstrative aspects, radios 114 and/or 144 may include one or more wireless transmitters (Tx) including circuitry and/or logic to transmit wireless communication signals, RF signals, frames, blocks, transmission streams, packets, messages, data items, and/or data. For example, a radio 114 may include at least one transmitter 118, and/or a radio 144 may include at least one transmitter 148.

In some demonstrative aspects, radios 114 and/or 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radios 114 and/or 144 may include or may be implemented as part of a wireless Network Interface Card (NIC), and the like.

In some demonstrative aspects, radios 114 and/or 144 may be configured to communicate over a sub-10 GHz band, for example, a sub-7 GHz band, for example, a 2.4 GHz band, a 5 GHz band, a 6 GHz band, and/or any other sub-10 GHz and/or sub-7 GHz band; and/or an mmWave band, e.g., a 45 GHz band, a 60 GHz band, a band between 42.5 GHz and 71 GHz, and/or any other mmWave band; and/or any other band, e.g., a 5G band, an S1G band, and/or any other band.

In some demonstrative aspects, radios 114 and/or 144 may include, or may be associated with one or more antennas.

In some demonstrative aspects, device 102 may include one or more antennas 107, and/or device 140 may include one or more antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors 127 including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory 125, e.g., coupled to the one or more processors 127, which may be configured, for example, to store, e.g., at least temporarily, at least some of the information processed by the one or more processors and/or circuitry 127, and/or which may be configured to store logic to be utilized by the processors and/or circuitry 127.

In one example, controller 154 may include circuitry and/or logic, for example, one or more processors 157 including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory 155, e.g., coupled to the one or more processors 157, which may be configured, for example, to store, e.g., at least temporarily, at least some of the information processed by the one or more processors and/or circuitry 157, and/or which may be configured to store logic to be utilized by the processors and/or circuitry 157.

In some demonstrative aspects, at least part of the functionality of controller 124 may be implemented as part of one or more elements of radio 114, and/or at least part of the functionality of controller 154 may be implemented as part of one or more elements of radio 144.

In other aspects, the functionality of controller 124 may be implemented as part of any other element of device 102, and/or the functionality of controller 154 may be implemented as part of any other element of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or more messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of radio 114, and/or at least part of the functionality of message processor 158 may be implemented as part of radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of one or more radios 114. For example, the chip or SoC may include one or more elements of controller 124, one or more elements of message processor 128, and/or one or more elements of one or more radios 114. In one example, controller 124, message processor 128, and one or more radios 114 may be implemented as part of the chip or SoC.

In other aspects, controller 124, message processor 128 and/or the one or more radios 114 may be implemented by one or more additional or alternative elements of device 102.

In some demonstrative aspects, at least part of the functionality of controller 154 and/or message processor 158 may be implemented by an integrated circuit, for example, a chip, e.g., a SoC. In one example, the chip or SoC may be configured to perform one or more functionalities of one or more radios 144. For example, the chip or SoC may include one or more elements of controller 154, one or more elements of message processor 158, and/or one or more elements of one or more radios 144. In one example, controller 154, message processor 158, and one or more radios 144 may be implemented as part of the chip or SoC.

In other aspects, controller 154, message processor 158 and/or one or more radios 144 may be implemented by one or more additional or alternative elements of device 140.

In some demonstrative aspects, device 102 and/or device 140 may include, operate as, perform the role of, and/or perform one or more functionalities of, one or more STAs. For example, device 102 may include at least one STA, and/or device 140 may include at least one STA.

In some demonstrative aspects, device 102 and/or device 140 may include, operate as, perform the role of, and/or perform one or more functionalities of, one or more Extremely High Throughput (EHT) STAs. For example, device 102 may include, operate as, perform the role of, and/or perform one or more functionalities of, one or more EHT STAs, and/or device 140 may include, operate as, perform the role of, and/or perform one or more functionalities of, one or more EHT STAs.

In some demonstrative aspects, for example, device 102 and/or device 140 may be configured to perform one or more operations, and/or functionalities of a Wi-Fi 8 STA.

In other aspects, for example, devices 102 and/or 140 may be configured to perform one or more operations, and/or functionalities of an Ultra High Reliability (UHR) STA.

In other aspects, for example, devices 102 and/or 140 may be configured to perform one or more operations, and/or functionalities of an Integrated mmWave (IMMW) STA.

In other aspects, for example, devices 102 and/or 140 may be configured to perform one or more operations, and/or functionalities of any other additional or alternative type of STA.

In other aspects, devices 102, and/or 140 may include, operate as, perform the role of, and/or perform one or more functionalities of, any other wireless device and/or station, e.g., a WLAN STA, a Wi-Fi STA, and the like.

In some demonstrative aspects, device 102 and/or device 140 may be configured to operate as, perform the role of, and/or perform one or more functionalities of, an access point (AP), e.g., an EHT AP STA, a UHR AP STA, and/or an IMMW AP STA.

In some demonstrative aspects, device 102 and/or device 140 may be configured to operate as, perform the role of, and/or perform one or more functionalities of, a non-AP STA, e.g., an EHT non-AP STA, a UHR non-AP STA, and/or an IMMW non-AP STA.

In other aspects, device 102 and/or device 140 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains one station (STA) and provides access to the distribution services, via the wireless medium (WM) for associated STAs. An AP may include a STA and a distribution system access function (DSAF). The AP may perform any other additional or alternative functionality.

In some demonstrative aspects devices 102 and/or 140 may be configured to communicate in an EHT network, a UHR network, an IMMW network, and/or any other network.

In some demonstrative aspects, devices 102, 140 and/or 150 may be configured to operate in accordance with one or more Specifications, for example, including one or more IEEE 802.11 Specifications, e.g., an IEEE 802.11-2020 Specification, an IEEE 802.11be Specification, an IEEE 802.11-2020 Specification, an IEEE 802.11bn Specification, and/or any other specification and/or protocol.

In some demonstrative aspects, device 102 and/or device 140 may include, operate as, perform a role of, and/or perform the functionality of, one or more multi-link logical entities, e.g., as described below.

In other aspect, device 102 and/or device 140 may include, operate as, perform a role of, and/or perform the functionality of, any other entities, e.g., which are not multi-link logical entities.

For example, a multi-link logical entity may include a logical entity that contains one or more STAs. The logical entity may have one MAC data service interface and primitives to the logical link control (LLC) and a single address associated with the interface, which can be used to communicate on a distribution system medium (DSM). For example, the DSM may include a medium or set of media used by a distribution system (DS) for communications between APs, mesh gates, and the portal of an extended service set (ESS). For example, the DS may include a system used to interconnect a set of basic service sets (BSSs) and integrated local area networks (LANs) to create an extended service set (ESS). In one example, a multi-link logical entity may allow STAs within the multi-link logical entity to have the same MAC address. The multi-link entity may perform any other additional or alternative functionality.

In some demonstrative aspects, device 102 and/or device 140 may include, operate as, perform a role of, and/or perform the functionality of, a Multi-Link Device (MLD). For example, device 102 may include, operate as, perform a role of, and/or perform the functionality of, at least one MLD, and/or device 140 may include, operate as, perform a role of, and/or perform the functionality of, at least one MLD, e.g., as described below.

For example, an MLD may include a device that is a logical entity that is capable of supporting more than one affiliated station (STA) and can operate using one or more affiliated STAs. For example, the MLD may present one Medium Access Control (MAC) data service and a single MAC Service Access Point (SAP) to the Logical Link Control (LLC) sublayer. The MLD may perform any other additional or alternative functionality.

In some demonstrative aspects, for example, an infrastructure framework may include a multi-link AP logical entity, which includes APs, e.g., on one side, and a multi-link non-AP logical entity, which includes non-APs, e.g., on the other side.

In some demonstrative aspects, device 102 and/or device 140 may be configured to operate as, perform the role of, and/or perform one or more functionalities of, an AP MLD.

In some demonstrative aspects, device 102 and/or device 140 may be configured to operate as, perform the role of, and/or perform one or more functionalities of, a non-AP MLD.

In other aspects, device 102 and/or device 140 may operate as, perform the role of, and/or perform one or more functionalities of, any other additional or alternative device and/or station.

For example, an AP MLD may include an MLD, where each STA affiliated with the MLD is an AP. In one example, the AP MLD may include a multi-link logical entity, where each STA within the multi-link logical entity is an EHT AP. The AP MLD may perform any other additional or alternative functionality.

For example, a non-AP MLD may include an MLD, where each STA affiliated with the MLD is a non-AP STA. In one example, the non-AP MLD may include a multi-link logical entity, where each STA within the multi-link logical entity is a non-AP EHT STA. The non-AP MLD may perform any other additional or alternative functionality.

In one example, a multi-link infrastructure framework may be configured as an extension from a one link operation between two STAs, e.g., an AP and a non-AP STA.

In some demonstrative aspects, controller 124 may be configured to control, trigger, cause, and/or instruct device 102 to operate as, perform a role of, and/or perform one or more operations and/or functionalities of, an AP MLD 131 including a plurality of STAs 133, e.g., including an AP STA 135, an AP STA 137, an AP STA 139, and/or an mmWave STA 141, which may be affiliated with the AP MLD 131. In some aspects, as shown in FIG. 1, AP MLD 131 may include four STAs. In other aspects, AP MLD 131 may include any other number of STAs.

In one example, AP STA 135, AP STA 137, AP STA 139, and/or mmWave STA 141 may operate as, perform a role of, and/or perform one or more operations and/or functionalities of, an EHT AP STA. In other aspects, AP STA 135, AP STA 137, AP STA 139, and/or mmWave STA 141 may perform any other additional or alternative functionality.

In some demonstrative aspects, mmWave STA 141 may operate as, perform a role of, and/or perform one or more operations and/or functionalities of, an mmWave AP STA. In other aspects, mmWave STA 141 may operate as, perform a role of, and/or perform one or more operations and/or functionalities of an mmWave network controller to control communication over an mmWave wireless communication network.

In some demonstrative aspects, for example, the one or more radios 114 may include, for example, a radio for communication by AP STA 135 over a first wireless communication frequency channel and/or frequency band, e.g., a 2.4 GHz band, as described below.

In some demonstrative aspects, for example, the one or more radios 114 may include, for example, a radio for communication by AP STA 137 over a second wireless communication frequency channel and/or frequency band, e.g., a 5 GHz band, as described below.

In some demonstrative aspects, for example, the one or more radios 114 may include, for example, a radio for communication by AP STA 139 over a third wireless communication frequency channel and/or frequency band, e.g., a 6 GHz band, as described below.

In some demonstrative aspects, for example, the one or more radios 114 may include, for example, a radio for communication by mmWave STA 141 over a fourth wireless communication frequency channel and/or frequency band, e.g., an mmWave band, for example, a wireless communication band above 40 GHz, for example, a frequency band above 45 GHz, e.g., a 60 GHz frequency band, a frequency band between 42.5 GHz and 71 GHz, and/or any other mmWave frequency band, e.g., as described below.

In some demonstrative aspects, the radios 114 utilized by STAs 133 may be implemented as separate radios. In other aspects, the radios 114 utilized by STAs 133 may be implemented by one or more shared and/or common radios and/or radio components.

In other aspects, controller 124 may be configured to control, trigger, cause, and/or instruct device 102 to operate as, perform a role of, and/or perform one or more operations and/or functionalities of, any other additional or alternative entity and/or STA, e.g., a single STA, multiple STAs, and/or a non-MLD entity.

In some demonstrative aspects, controller 154 may be configured to control, trigger, cause, and/or instruct device 140 to operate as, perform a role of, and/or perform one or more operations and/or functionalities of, an MLD 151 including a plurality of STAs 153, e.g., including a STA 155, a STA 157, a STA 159, and/or a STA 161, which may be affiliated with the MLD 151. In some aspects, as shown in FIG. 1, MLD 151 may include four STAs. In other aspects, MLD 151 may include any other number of STAs.

In one example, STA 155, STA 157, STA 159, and/or STA 161 may operate as, perform a role of, and/or perform one or more operations and/or functionalities of, an EHT STA. In other aspects, STA 155, STA 157, STA 159, and/or STA 161 may perform any other additional or alternative functionality.

In some demonstrative aspects, STA 161 may be configured to operate as, perform a role of, and/or perform one or more operations and/or functionalities of, an mm Wave STA, e.g., as described below. For example, the mmWave STA 161 may be configured to operate as, perform a role of, and/or perform one or more operations and/or functionalities of, a non-AP mm Wave STA, e.g., as described below.

In some demonstrative aspects, for example, the one or more radios 144 may include, for example, a radio for communication by STA 155 over a first wireless communication frequency channel and/or frequency band, e.g., a 2.4 GHz band, as described below.

In some demonstrative aspects, for example, the one or more radios 144 may include, for example, a radio for communication by STA 157 over a second wireless communication frequency channel and/or frequency band, e.g., a 5 GHz band, as described below.

In some demonstrative aspects, for example, the one or more radios 144 may include, for example, a radio for communication by STA 159 over a third wireless communication frequency channel and/or frequency band, e.g., a 6 GHz band, as described below.

In some demonstrative aspects, for example, the one or more radios 144 may include, for example, a radio for communication by mmWave STA 161 over a fourth wireless communication frequency channel and/or frequency band, e.g., an mmWave band, as described below.

In some demonstrative aspects, the radios 144 utilized by STAs 153 may be implemented as separate radios. In other aspects, the radios 144 utilized by STAs 153 may be implemented by one or more shared and/or common radios and/or radio components.

In some demonstrative aspects, controller 154 may be configured to control, trigger, cause, and/or instruct MLD 151 to operate as, perform a role of, and/or perform one or more operations and/or functionalities of, a non-AP MLD. For example, STA 155, STA 157, STA 159, and/or mmWave STA 161 may operate as, perform a role of, and/or perform one or more operations and/or functionalities of, a non-AP STA, e.g., a non-AP EHT STA.

In some demonstrative aspects, controller 154 may be configured to control, trigger, cause, and/or instruct MLD 151 to operate as, perform a role of, and/or perform one or more operations and/or functionalities of, an AP MLD. For example, STA 155, STA 157, STA 159, and/or mmWave STA 161 may operate as, perform a role of, and/or perform one or more operations and/or functionalities of, an AP EHT STA.

In other aspects, controller 154 may be configured to control, trigger, cause, and/or instruct device 140 to operate as, perform a role of, and/or perform one or more operations and/or functionalities of, any other additional or alternative entity and/or STA, e.g., a single STA, multiple STAs, and/or a non-MLD entity.

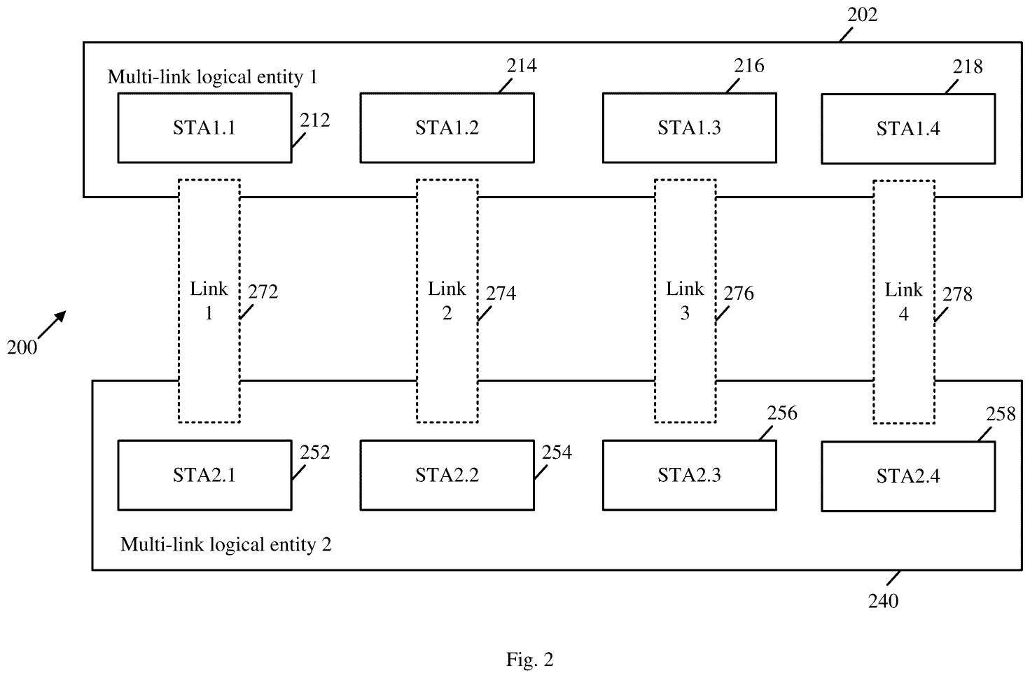

Reference is made to FIG. 2, which schematically illustrates a multi-link communication scheme 200, which may be implemented in accordance with some demonstrative aspects.

As shown in FIG. 2, a first multi-link logical entity 202 (“multi-link logical entity 1”), e.g., a first MLD, may include a plurality of STAs, e.g., including a STA 212, a STA 214, a STA 216, and a STA 218. In one example, AP MLD 131 (FIG. 1) may perform one or more operations of, one or more functionalities of, the role of, and/or the functionality of, multi-link logical entity 202.

As shown in FIG. 2, a second multi-link logical entity 240 (“multi-link logical entity 2”), e.g., a second MLD, may include a plurality of STAs, e.g., including a STA 252, a STA 254, a STA 256, and a STA 258. In one example, MLD 151 (FIG. 1) may perform one or more operations of, one or more functionalities of, the role of, and/or the functionality of, multi-link logical entity 240.

As shown in FIG. 2, multi-link logical entity 202 and multi-link logical entity 240 may be configured to form, setup and/or communicate over a plurality of links, for example, including a link 272 between STA 212 and STA 252, a link 274 between STA 214 and STA 254, a link 276 between STA 216 and STA 256, and/or a link 278 between STA 218 and STA 258.

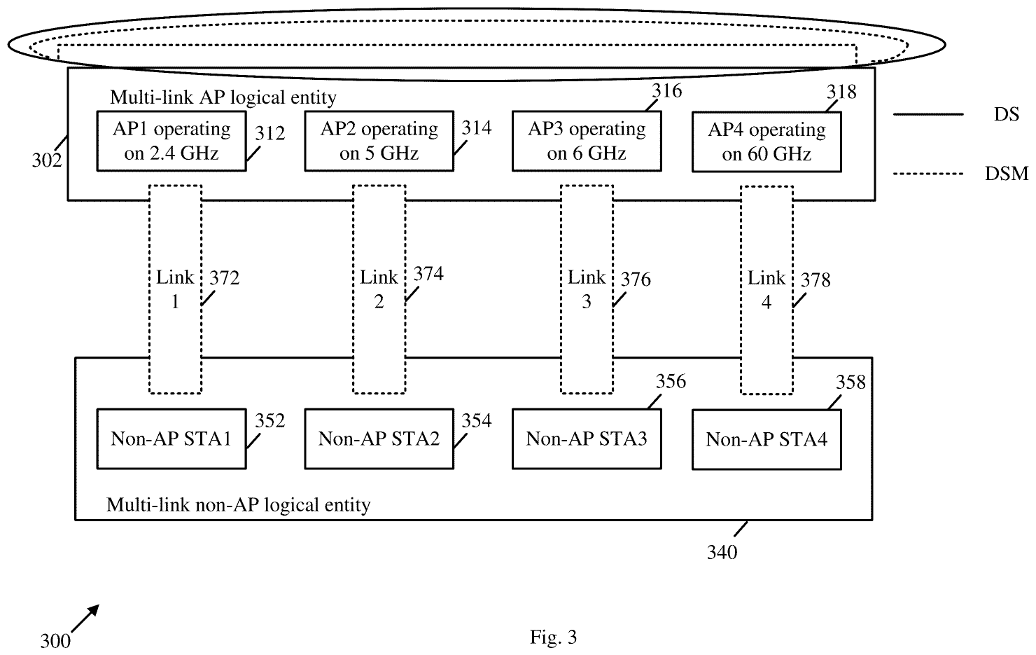

Reference is made to FIG. 3, which schematically illustrates a multi-link communication scheme 300, which may be implemented in accordance with some demonstrative aspects.

As shown in FIG. 3, a multi-link AP logical entity 302, e.g., an AP MLD, may include a plurality of AP STAs, e.g., including an AP STA 312, an AP STA 314, an AP STA 316, and an mmWave STA 318. In one example, AP MLD 131 (FIG. 1) may perform one or more operations of, one or more functionalities of, the role of, and/or the functionality of, multi-link AP logical entity 302.

As shown in FIG. 3, a multi-link non-AP logical entity 340, e.g., a non-AP MLD, may include a plurality of non-AP STAs, e.g., including a non-AP STA 352, a non-AP STA 354, a non-AP STA 356, and an mmWave STA 358. In one example, MLD 151 (FIG. 1) may perform one or more operations of, one or more functionalities of, the role of, and/or the functionality of, multi-link non-AP logical entity 340.

As shown in FIG. 3, multi-link AP logical entity 302 and multi-link non-AP logical entity 340 may be configured to form, setup and/or communicate over a plurality of links, for example, including a link 372 between AP STA 312 and non-AP STA 352, a link 374 between AP STA 314 and non-AP STA 354, a link 376 between AP STA 316 and non-AP STA 356, and/or a link 378 between mmWave STA 318 and mmWave STA 358.

For example, as shown in FIG. 3, multi-link AP logical entity 302 may include a multi-band AP MLD, which may be configured to communicate over a plurality of wireless communication frequency bands. For example, as shown in FIG. 3, AP STA 312 may be configured to communicate over a 2.4 GHz frequency band, AP STA 314 may be configured to communicate over a 5 GHz frequency band, AP STA 316 may be configured to communicate over a 6 GHz frequency band, and/or mmWave STA 318 may be configured to communicate over an mmWave frequency band. In other aspects, AP STA 312, AP STA 314, AP STA 316, and/or mm Wave STA 318 may be configured to communicate over any other additional or alternative wireless communication frequency bands.

Referring back to FIG. 1, in some demonstrative aspects, device 102 and/or device 140 may be configured to perform one or more operations of a multi-link power management mechanism (also referred to as a “cross-link power management mechanism” or a “cross-link power save mechanism”), e.g., as describe below.

In some demonstrative aspects, device 102 and/or device 140 may be configured to perform one or more operations of a multi-link power management mechanism, which may be configured, in accordance with, and/or in compliance with, an IEEE 802.11be Standard, an IEEE 802.11bn Standard, and/or any other suitable multi-link protocol, standard and/or specification, e.g., as described below.

In some demonstrative aspects, controller 124 may be configured to control, trigger, cause, and/or instruct AP MLD 131 to operate as, perform a role of, and/or perform one or more operations and/or functionalities of, a Multi-Link Power Management (MLPM) AP MLD 131, which may be configured to support one or more operations of a multi-link power management mechanism, e.g., as described below.

For example, the AP MLD 131 may be configured to set a multi-link power management field to a predefined value, e.g., a value of “1”, for example, to indicate that the AP MLD 131 is operable as the MLPM AP MLD 131, e.g., in accordance with an IEEE 802.11bn Specification. For example, the AP MLD 131 may be configured to set the multi-link power management field to “1”, for example, in a UHR MAC capabilities element in management frames that the AP MLD 131 transmits.

In some demonstrative aspects, controller 154 may be configured to control, trigger, cause, and/or instruct non-AP MLD 151 to operate as, perform a role of, and/or perform one or more operations and/or functionalities of, an MLPM non-AP MLD 151, which may be configured to support one or more operations of a multi-link power management mechanism, e.g., as described below.

For example, the non-AP MLD 151 may be configured to set a multi-link power management field to a predefined value, e.g., a value of “1”, for example, to indicate that the non-AP MLD 151 is operable as the MLPM non-AP MLD 151, e.g., in accordance with an IEEE 802.11bn Specification. For example, the non-AP MLD 151 may be configured to set the multi-link power management field to “1”, for example, in a UHR MAC capabilities element in management frames that the non-AP MLD 151 transmits.

In some demonstrative aspects, device 102 and/or device 140 may be configured to perform one or more operations of a cross link power save mechanism, which may be implemented between an AP MLD, e.g., an AP MLD 131 implemented by device 102, and a non-AP MLD, e.g., a non-AP MLD 151 implemented by device 140, e.g., as described below.

For example, it may be defined according to the cross link power save mechanism that the non-AP MLD can transmit a frame, e.g., through its first affiliated STA (STA1) on a first link (link 1), for example, to indicate a change in a power management mode, e.g., a change in a power state or a change in a power save mode, for at least one second affiliated STA (STA2) of the non-AP MLD operating on another link (link 2), e.g., as described below.

For example, it may be defined according to the cross link power save mechanism that a STA affiliated with a non-AP MLD can transmit a frame to its associated AP MLD on one link (link 1) to indicate that another STA affiliated with the non-AP MLD and operating on another link (link 2, 3, . . . ) is changing its power state (awake to doze or doze to awake) or its power mode (active mode to power save mode, or power save mode to active mode).

In one example, it may be defined that a non-AP STA affiliated with an MLPM non-AP MLD may transmit a frame that carries a multi-link power management field, e.g., an MLPM Control subfield, to change the power management mode of one or more other non-AP STA(s) affiliated with the same non-AP MLD and operating on an enabled link.

For example, the non-AP STA 155 affiliated with the MLPM non-AP MLD 151 may transmit a frame that carries a multi-link power management field, e.g., an MLPM Control subfield, to change the power management mode of one or more other non-AP STA(s), e.g., STA 157, STA 159 and/or STA 161, affiliated with the same non-AP MLD 151 and operating on an enabled link.

For example, it may be defined according to the cross link power save mechanism that the change in the power save mode may be signaled for more than one other link (link2) of the non-AP MLD. For example, the frame transmitted by the non-AP STA over the link 1 may be configured to indicate the power management mode change for multiple other links (link 2, 3, . . . ).

For example, it may be defined according to the cross link power save mechanism that the change in the power save mode may be signaled along with a power state/mode change in the current link, e.g., the link1.

For example, it may be defined according to the cross link power save mechanism that the AP MLD may know that the STA2 on the link2 is transitioning its power state/mode and will become available or unavailable, for example, based on the information received form the non-AP MLD over the link1, indicting the change in the power management mode for the STA on the link2.

In one example, it may be defined that, if an MLPM AP MLD receives, via an affiliated AP, a power management mode change for a non-AP STA affiliated with an associated MLPM non-AP MLD and operating on an enabled link, then the AP affiliated with the MLPM AP MLD and operating on the corresponding enabled link is to follow on or more rules for multi-link power management for the changed power management mode of the non-AP STA, for example, as if the AP had received, on the link, a frame, from the non-AP STA, that indicates the same power management change.

For example, the cross link power save mechanism may be implemented to provide a technical solution to support improved and/or efficient power management at non-AP MLDs, for example, compared to implementations where power save is handled per link.

For example, in implementations where power save is handled per link, a non-AP MLD may be required to send a frame to change a power state/mode over each corresponding link on which the power state/mode is to be changed. This requirement may be burdensome, e.g., especially in cases where the power state/mode is to be changed simultaneously on multiple links. In one example, the power state/mode may be changed simultaneously on multiple links in case of an Enhanced Multi Link Single Radio (EMLSR) operation mode, or the like.

In some demonstrative aspects, in some use cases, scenarios and/or implementations, it may be difficult for an AP MLD, e.g., depending on its architecture, to handle the power state/mode transition immediately, for example, in cases where there may be some communications between APs within the AP MLD. For example, there may be some implementations, which may have a relatively long delay for such AP communication within the AP MLD.

For example, in a first case, a first STA (STA1) affiliated with a non-AP MLD may transmit a frame to its associated AP MLD on a first link (link 1) to indicate that a second STA (STA2) affiliated with the non-AP MLD and operating on a second link (link 2) is to change from an active power management mode to a doze power management mode, for example, through a power state change, e.g., from an awake power state to a doze power state, or through a power mode change, e.g., from an active power mode to a power save mode.

For example, in the first case, it may be disadvantageous to allow the STA2 to change its power save mode immediately after the AP MLD has acknowledged the frame sent by the STA1 and including the signaling for power save mode change. For example, the AP of the AP MLD, which is associated with the STA2 over the link2, may not yet be aware of the change in the power management mode of the STA2, e.g., due to the processing delay across the links at the AP MLD. As a result, the AP of the AP MLD, which is associated with the STA2 over the link2, may attempt sending one or more frames to the STA2 over the link2, while the STA2, which may have already transitioned to the doze power management mode, may not be able to receive these frames, and/or to respond to these frames.

For example, in a second case, a first STA (STA1) affiliated with a non-AP MLD may transmit a frame to its associated AP MLD on a first link (link 1) to indicate that a second STA (STA2) affiliated with the non-AP MLD and operating on a second link (link 2) is to change from a doze power management mode to an active power management mode, for example, through a power state change, e.g., from a doze power state to an awake power state, or through a power mode change, e.g., from a power save mode to an active power mode.

For example, in the second case, it may be disadvantageous to allow the STA2 to change its power save mode immediately after the AP MLD has acknowledged the frame sent by the STA1 and including the signaling for power save mode change. For example, the AP of the AP MLD, which is associated with the STA2 over the link2, may not yet be aware of the change in the power management mode of the STA2, e.g., due to the processing delay across the links at the AP MLD. As a result, the AP of the AP MLD, which is associated with the STA2 over the link2, may refrain from sending any frames to the STA2, e.g., until the AP is aware that the STA2 has transitioned to the active power management mode. As a result, the STA2 may be at the active power management mode for a period of time, e.g., corresponding to the processing delay of the AP MLD, during which the AP of the AP MLD may not transmit any frame to the STA2, because the AP does not know that the STA is awake. Accordingly, power of the STA2 may be wasted during this time period.

In some demonstrative aspects, device 102 and/or device 140 may be configured to perform one or more operations of a multi-link power management mechanism, which may be configured to provide a technical solution to support a multi-link power management mode change, which may be based on a processing delay on the AP MLD side, e.g., as described below.

In some demonstrative aspects, device 102 and/or device 140 may be configured to perform one or more operations of a multi-link power management mechanism, which may be configured to provide a technical solution to support a multi-link power management mode change, for example, while taking into account a processing delay on the AP MLD side, e.g., as described below.

In some demonstrative aspects, device 102 and/or device 140 may be configured to perform one or more operations of a multi-link power management mechanism, which may be configured to provide a technical solution to coordinate and/or substantially synchronize between a time at which a STA on the non-AP MLD changes its power management mode based on the multi-link power management signaling, and a time at which a corresponding AP on the AP MLD is to consider the STA on the non-AP MLD to have changed its power management mode based on the multi-link power management signaling, e.g., as described below.

In some demonstrative aspects, controller 124 may be configured to control, trigger, cause, and/or instruct an AP MLD 131 implemented by device 102 to operate as an MLPM AP MLD, e.g., as described below.

In some demonstrative aspects, controller 124 may be configured to control, trigger, cause, and/or instruct the AP MLD 131 implemented by device 102 to transmit a multi-link processing delay value in a first frame, e.g., as described below.

In some demonstrative aspects, the multi-link processing delay value may be based, for example, on a multi-link processing delay time for the AP MLD 131, e.g., as described below.

In some demonstrative aspects, controller 124 may be configured to control, trigger, cause, and/or instruct the AP MLD 131 implemented by device 102 to process a second frame, which is received at a first AP affiliated with the AP MLD 131, e.g., AP 135, over a first link from a first non-AP STA, e.g., STA 155, affiliated with a non-AP MLD 151, e.g., as described below.

In some demonstrative aspects, controller 124 may be configured to control, trigger, cause, and/or instruct the AP MLD 131 implemented by device 102 to process the second frame, for example, to identify and/or determine a multi-link power management field to change a power management mode for at least one second non-AP STA, e.g., STA 157, STA 159, and/or STA 161, which is affiliated with the non-AP MLD 151, and which is operative over at least one second link with at least one second AP, e.g., AP 137, affiliated with the AP MLD 131, e.g., as described below.

In some demonstrative aspects, the multi-link power management field may be configured to change the power management mode for the at least one second non-AP STA, for example, from a first power management mode to a second power management mode, e.g., as described below.

In some demonstrative aspects, controller 124 may be configured to control, trigger, cause, and/or instruct the AP MLD 131 implemented by device 102 to cause at least one second AP, e.g., AP 137, which is affiliated with the AP MLD 131 and which is operative over the at least one second link with the at least one second non-AP STA, to consider the change in the power management mode for the at least one second non-AP STA to occur, for example, at a time that is based on the multi-link processing delay time for the AP MLD 131, e.g., as described below.

In some demonstrative aspects, controller 124 may be configured to control, trigger, cause, and/or instruct the AP MLD 131 implemented by device 102 to determine the time at which the power management mode for the at least one second non-AP STA is to be changed from the first power management mode to the second power management mode, for example, based on the multi-link processing delay time for the AP MLD, e.g., as described below.

In some demonstrative aspects, the multi-link processing delay time for the AP MLD 131 may include a time interval between a first time and a second time, e.g., as described below.

In some demonstrative aspects, the first time may be based, for example, on a time at which the multi-link power management field to change the power management mode is received at the first AP 135, e.g., as described below.

In some demonstrative aspects, the first time may be based, for example, on a time at which the multi-link power management field to change the power management mode is acknowledged by the first AP 135, e.g., as described below.

In some demonstrative aspects, the second time may be based, for example, on a time at which the multi-link power management field to change the power management mode is processed at the at least one second AP 137, e.g., as described below.

In other aspects, the multi-link processing delay time for the AP MLD 131 may be defined based on any other additional or alternative criteria and/or parameters.

In some demonstrative aspects, the change of the power management mode for the at least one second non-AP STA may include a change of a power state for the at least one second non-AP STA, e.g., as described below.

In some demonstrative aspects, the change of the power state for the at least one second non-AP STA may include, for example, a change from an awake power state to a doze power state.

In some demonstrative aspects, the change of the power state for the at least one second non-AP STA may include, for example, a change from the doze power state to the awake power state.

In some demonstrative aspects, the change of the power management mode for the at least one second non-AP STA may include a change of a power mode for the at least one second non-AP STA, e.g., as described below.

In some demonstrative aspects, the change of the power mode for the at least one second non-AP STA may include, for example, a change from an active power mode to a power save mode.

In some demonstrative aspects, the change of the power mode for the at least one second non-AP STA may include, for example, a change from the power save mode to the active power mode.

In other aspects, the change of the power management mode for the at least one second non-AP STA may include any other power mode change, power state change, power setting change, and/or any other change in the power management mode for the at least one second non-AP STA.

In some demonstrative aspects, controller 124 may be configured to control, trigger, cause, and/or instruct the AP MLD 131 implemented by device 102 to set the multi-link processing delay value in the first frame including a management frame from the AP MLD 131, e.g., as described below.

In some demonstrative aspects, controller 124 may be configured to control, trigger, cause, and/or instruct the AP MLD 131 implemented by device 102 to set the multi-link processing delay value in the first frame including a broadcasted frame from the AP MLD 131.

In some demonstrative aspects, controller 124 may be configured to control, trigger, cause, and/or instruct the AP MLD 131 implemented by device 102 to set the multi-link processing delay value in the first frame including a broadcasted beacon frame from the AP MLD 131.

In some demonstrative aspects, controller 124 may be configured to control, trigger, cause, and/or instruct the AP MLD 131 implemented by device 102 to set the multi-link processing delay value in the first frame including a broadcast probe response frame from the AP MLD.

In some demonstrative aspects, controller 124 may be configured to control, trigger, cause, and/or instruct the AP MLD 131 implemented by device 102 to set the multi-link processing delay value in the first frame including a unicast frame from the AP MLD 131 to the non-AP MLD 151, e.g., as described below.

In some demonstrative aspects, controller 124 may be configured to control, trigger, cause, and/or instruct the AP MLD 131 implemented by device 102 to set the multi-link processing delay value in the first frame including a unicast probe response frame from the AP MLD 131 to the non-AP MLD 151.

In some demonstrative aspects, controller 124 may be configured to control, trigger, cause, and/or instruct the AP MLD 131 implemented by device 102 to set the multi-link processing delay value in the first frame including a unicast association response frame from the AP MLD 131 to the non-AP MLD 151.

In some demonstrative aspects, controller 124 may be configured to control, trigger, cause, and/or instruct the AP MLD 131 implemented by device 102 to set the multi-link processing delay value in a multi-link processing delay subfield in the first frame, e.g., as described below.

In some demonstrative aspects, controller 124 may be configured to control, trigger, cause, and/or instruct the AP MLD 131 implemented by device 102 to set the multi-link processing delay subfield in a multi-link element of the first frame.

In some demonstrative aspects, controller 124 may be configured to control, trigger, cause, and/or instruct the AP MLD 131 implemented by device 102 to set the multi-link processing delay subfield in a common information (info) field of the multi-link element.

In some demonstrative aspects, controller 124 may be configured to control, trigger, cause, and/or instruct the AP MLD 131 implemented by device 102 to set the multi-link processing delay subfield in a per-user information (info) field of the multi-link element.

In other aspects, the multi-link processing delay subfield may be included as part of any other suitable field of the multi-link element.

In some demonstrative aspects, controller 124 may be configured to control, trigger, cause, and/or instruct the AP MLD 131 implemented by device 102 to set the multi-link processing delay value in a Cross Link Processing Delay (CLPD) subfield in the first frame.

In other aspects, the multi-link processing delay subfield may be included as part of any other suitable element and/or field of the first frame.

In some demonstrative aspects, controller 124 may be configured to control, trigger, cause, and/or instruct the AP MLD 131 implemented by device 102 to set the multi-link processing delay value in the first frame based, for example, on a predefined mapping between the multi-link processing delay value and a predefined multi-link processing delay time, e.g., as described below.

In some demonstrative aspects, controller 124 may be configured to control, trigger, cause, and/or instruct the AP MLD 131 implemented by device 102 to set the multi-link processing delay value in the first frame based, for example, on a predefined mapping between a plurality of multi-link processing delay values and a respective plurality of predefined multi-link processing delay times, e.g., as described below.

In some demonstrative aspects, controller 124 may be configured to control, trigger, cause, and/or instruct the AP MLD 131 implemented by device 102 to determine the multi-link processing delay time for the AP MLD 131 to be no more than a predefined maximal multi-link processing delay time, e.g., as described below.

In some demonstrative aspects, controller 124 may be configured to control, trigger, cause, and/or instruct the AP MLD 131 implemented by device 102 to consider the at least one second non-AP STA to be at the first power management mode, for example, during a delay time interval after the second frame, e.g., as described below.

In some demonstrative aspects, a duration of the delay time interval may be based, for example, on the multi-link processing delay time for the AP MLD, e.g., as described below.

In some demonstrative aspects, controller 124 may be configured to control, trigger, cause, and/or instruct the AP MLD 131 implemented by device 102 to determine a beginning of the delay time interval based, for example, on an Acknowledgement (ACK) from the first AP 135, for example, to acknowledge the change of the power management mode for the at least one second non-AP STA, e.g., as described below.

In some demonstrative aspects, controller 124 may be configured to control, trigger, cause, and/or instruct the AP MLD 131 implemented by device 102 to consider the at least one second non-AP STA to be at the second power management mode, for example, after the delay time interval, e.g., as described below.

In some demonstrative aspects, the duration of the delay time interval may be determined to be equal to the multi-link processing delay time for the AP MLD, e.g., as described below.

In other aspects, any other suitable duration of the delay time interval may be defined based on the multi-link processing delay time for the AP MLD.

In some demonstrative aspects, controller 124 may be configured to control, trigger, cause, and/or instruct the AP MLD 131 implemented by device 102 to process a third frame from the second non-AP STA, e.g., as described below.

In some demonstrative aspects, the third frame may be received at the second AP 137 over the second link, for example, after the second frame and before the time at which the power management mode for the at least one second non-AP STA is to be changed based on the multi-link processing delay time for the AP MLD 131, e.g., as described below.

In some demonstrative aspects, the third frame may include the multi-link power management field to change the power management mode for the second non-AP STA, e.g., as described below.

In some demonstrative aspects, controller 124 may be configured to control, trigger, cause, and/or instruct the AP MLD 131 implemented by device 102 to transmit an ACK from the second AP 137, for example, to acknowledge the change of the power management mode for the second non-AP STA based on the third frame, e.g., as described below.

In some demonstrative aspects, controller 154 may be configured to control, trigger, cause, and/or instruct a non-AP MLD 151 implemented by device 140 to operate as an MLPM non-AP MLD, e.g., as described below.

In some demonstrative aspects, controller 154 may be configured to control, trigger, cause, and/or instruct the non-AP MLD 151 implemented by device 140 to process a multi-link processing delay value in a first frame from an AP MLD, e.g., the AP MLD 131, to identify and/or determine a multi-link processing delay time for the AP MLD.

For example, the first frame, which is received by the non-AP MLD 151 implemented by device 140, may include the first frame transmitted from the AP MLD 131 implemented by device 102.

In some demonstrative aspects, controller 154 may be configured to control, trigger, cause, and/or instruct the non-AP MLD 151 implemented by device 140 to transmit a second frame from a first non-AP STA, e.g., non-AP STA 155, affiliated with the non-AP MLD 151, to the AP MLD 131 over a first link, e.g., as described below.

In some demonstrative aspects, the second frame may include a multi-link power management field to change a power management mode for at least one second non-AP STA from a first power management mode to a second power management mode, e.g., as described below.

In some demonstrative aspects, the at least one second non-AP STA may include a non-AP STA, e.g., STA 157, STA 159, and/or STA 161, which may be affiliated with the non-AP MLD 151 and may be operative over at least one second link with the AP MLD 131, e.g., as described below.

In some demonstrative aspects, controller 154 may be configured to control, trigger, cause, and/or instruct the non-AP MLD 151 implemented by device 140 to change the power management mode for the at least one second non-AP STA, e.g., STA 157, STA 159, and/or STA 161, from the first power management mode to the second power management mode, for example, based on the multi-link processing delay time for the AP MLD 131, e.g., as described below.

In some demonstrative aspects, controller 154 may be configured to control, trigger, cause, and/or instruct the non-AP MLD 151 implemented by device 140 to set the change of the power management mode for the at least one second non-AP STA, e.g., STA 157, STA 159, and/or STA 161, to include, for example, a change of a power state for the at least one second non-AP STA, e.g., as described below.

In some demonstrative aspects, controller 154 may be configured to control, trigger, cause, and/or instruct the non-AP MLD 151 implemented by device 140 to set the change of the power management mode for the at least one second non-AP STA, e.g., STA 157, STA 159, and/or STA 161, to include, for example, a change from an awake power state to a doze power state.

In some demonstrative aspects, controller 154 may be configured to control, trigger, cause, and/or instruct the non-AP MLD 151 implemented by device 140 to set the change of the power management mode for the at least one second non-AP STA, e.g., STA 157, STA 159, and/or STA 161, to include, for example, a change from the doze power state to the awake power state.

In some demonstrative aspects, controller 154 may be configured to control, trigger, cause, and/or instruct the non-AP MLD 151 implemented by device 140 to set the change of the power management mode for the at least one second non-AP STA, e.g., STA 157, STA 159, and/or STA 161, to include, for example, a change of a power mode for the at least one second non-AP STA, e.g., as described below.

In some demonstrative aspects, controller 154 may be configured to control, trigger, cause, and/or instruct the non-AP MLD 151 implemented by device 140 to set the change of the power management mode for the at least one second non-AP STA, e.g., STA 157, STA 159, and/or STA 161, to include, for example, a change from an active power mode to a power save mode.

In some demonstrative aspects, controller 154 may be configured to control, trigger, cause, and/or instruct the non-AP MLD 151 implemented by device 140 to set the change of the power management mode for the at least one second non-AP STA, e.g., STA 157, STA 159, and/or STA 161, to include, for example, a change from the power save mode to the active power mode.

In other aspects, the change of the power management mode for the at least one second non-AP STA, e.g., STA 157, STA 159, and/or STA 161, may include any other power mode change, power state change, power setting change, and/or any other change in the power management mode for the at least one second non-AP STA.

In some demonstrative aspects, controller 154 may be configured to control, trigger, cause, and/or instruct the non-AP MLD 151 implemented by device 140 to identify and/or determine the multi-link processing delay value in the first frame, which may include, for example, a management frame from the AP MLD 131, e.g., as described below.

In some demonstrative aspects, controller 154 may be configured to control, trigger, cause, and/or instruct the non-AP MLD 151 implemented by device 140 to identify and/or determine the multi-link processing delay value in the first frame, which may include, for example, a broadcasted frame from the AP MLD 131, e.g., as described below.

In some demonstrative aspects, controller 154 may be configured to control, trigger, cause, and/or instruct the non-AP MLD 151 implemented by device 140 to identify and/or determine the multi-link processing delay value in the first frame, which may include, for example, a broadcasted beacon frame from the AP MLD 131, e.g., as described below.

In some demonstrative aspects, controller 154 may be configured to control, trigger, cause, and/or instruct the non-AP MLD 151 implemented by device 140 to identify and/or determine the multi-link processing delay value in the first frame, which may include, for example, a broadcast probe response frame from the AP MLD 131, e.g., as described below.

In some demonstrative aspects, controller 154 may be configured to control, trigger, cause, and/or instruct the non-AP MLD 151 implemented by device 140 to identify and/or determine the multi-link processing delay value in the first frame, which may include, for example, a unicast frame from the AP MLD 131 to the non-AP MLD 151, e.g., as described below.

In some demonstrative aspects, controller 154 may be configured to control, trigger, cause, and/or instruct the non-AP MLD 151 implemented by device 140 to identify and/or determine the multi-link processing delay value in the first frame, which may include, for example, a unicast probe response frame from the AP MLD 131 to the non-AP MLD 151, e.g., as described below.

In some demonstrative aspects, controller 154 may be configured to control, trigger, cause, and/or instruct the non-AP MLD 151 implemented by device 140 to identify and/or determine the multi-link processing delay value in the first frame, which may include, for example, a unicast association response frame from the AP MLD 131 to the non-AP MLD 151, e.g., as described below.

In some demonstrative aspects, controller 154 may be configured to control, trigger, cause, and/or instruct the non-AP MLD 151 implemented by device 140 to identify and/or determine the multi-link processing delay value in a multi-link processing delay subfield in the first frame from the AP MLD 131, e.g., as described below.

In some demonstrative aspects, controller 154 may be configured to control, trigger, cause, and/or instruct the non-AP MLD 151 implemented by device 140 to identify and/or determine the multi-link processing delay subfield in a multi-link element of the first frame, e.g., as described below.

In some demonstrative aspects, controller 154 may be configured to control, trigger, cause, and/or instruct the non-AP MLD 151 implemented by device 140 to identify and/or determine the multi-link processing delay subfield in a common information (info) field of the multi-link element.

In some demonstrative aspects, controller 154 may be configured to control, trigger, cause, and/or instruct the non-AP MLD 151 implemented by device 140 to identify and/or determine the multi-link processing delay subfield in a per-user information (info) field of the multi-link element.

In other, controller 154 may be configured to control, trigger, cause, and/or instruct the non-AP MLD 151 implemented by device 140 to identify and/or determine the multi-link processing delay subfield in any other suitable field of the multiOlink element.

In some demonstrative aspects, controller 154 may be configured to control, trigger, cause, and/or instruct the non-AP MLD 151 implemented by device 140 to identify and/or determine the multi-link processing delay value in a Cross Link Processing Delay (CLPD) subfield in the first frame from the AP MLD 131, e.g., as described below.

In other, controller 154 may be configured to control, trigger, cause, and/or instruct the non-AP MLD 151 implemented by device 140 to identify and/or determine the multi-link processing delay value in any other suitable field of the first frame from the AP MLD 131, e.g., as described below.

In some demonstrative aspects, controller 154 may be configured to control, trigger, cause, and/or instruct the non-AP MLD 151 implemented by device 140 to determine the multi-link processing delay time for the AP MLD 131, for example, based on a predefined mapping between the multi-link processing delay value in the first frame from the AP MLD 131 and a predefined multi-link processing delay time, e.g., as described below.

In some demonstrative aspects, controller 154 may be configured to control, trigger, cause, and/or instruct the non-AP MLD 151 implemented by device 140 to determine the multi-link processing delay time for the AP MLD 131, for example, based on a predefined mapping between a plurality of multi-link processing delay values and a respective plurality of predefined multi-link processing delay times, e.g., as described below.

In some demonstrative aspects, controller 154 may be configured to control, trigger, cause, and/or instruct the non-AP MLD 151 implemented by device 140 to determine the multi-link processing delay time for the AP MLD 131 to be no more than a predefined maximal multi-link processing delay time, e.g., as described below.

In some demonstrative aspects, controller 154 may be configured to control, trigger, cause, and/or instruct the non-AP MLD 151 implemented by device 140 to maintain the at least one second non-AP STA, e.g., STA 157, STA 159, and/or STA 161, at the first power management mode, for example, during a delay time interval after the second frame, e.g., as described below.

In some demonstrative aspects, a duration of the delay time interval may be based, for example, on the multi-link processing delay time for the AP MLD 131, e.g., as determined based on the first frame from the AP MLD 131.

In some demonstrative aspects, controller 154 may be configured to control, trigger, cause, and/or instruct the non-AP MLD 151 implemented by device 140 to determine a beginning of the delay time interval, for example, based on an ACK from the AP MLD to acknowledge the change of the power management mode for the at least one second non-AP STA, e.g., as described below.

In some demonstrative aspects, controller 154 may be configured to control, trigger, cause, and/or instruct the non-AP MLD 151 implemented by device 140 to allow the at least one second non-AP STA, e.g., STA 157, STA 159, and/or STA 161, to change from the first power management mode to the second power management mode, for example, after the delay time interval, e.g., as descried below.

In some demonstrative aspects, troller 154 may be configured to control, trigger, cause, and/or instruct the non-AP MLD 151 implemented by device 140 to determine the duration of the delay time interval to be equal to the multi-link processing delay time for the AP MLD 131, e.g., as determined based on the first frame from the AP MLD 131.

In other aspects, any other suitable duration of the delay time interval may be defined based on the multi-link processing delay time for the AP MLD.

In some demonstrative aspects, controller 154 may be configured to control, trigger, cause, and/or instruct the non-AP MLD 151 implemented by device 140 to allow the second non-AP STA, e.g., STA 157, STA 159, and/or STA 161, to transmit a third frame to the AP MLD 131 over the second link, e.g., as described below.

In some demonstrative aspects, the third frame may be transmitted, for example, after the second frame and before a time for changing the power management mode for the second non-AP STA, e.g., STA 157, STA 159, and/or STA 161, for example, based on the multi-link processing delay time for the AP MLD.

In some demonstrative aspects, controller 154 may be configured to control, trigger, cause, and/or instruct the non-AP MLD 151 implemented by device 140 to set the third frame to include the multi-link power management field to change the power management mode for the second non-AP STA, e.g., STA 157, STA 159, and/or STA 161, e.g., as described below.

In some demonstrative aspects, controller 154 may be configured to control, trigger, cause, and/or instruct the non-AP MLD 151 implemented by device 140 to change the power management mode of the second non-AP STA, e.g., STA 157, STA 159, and/or STA 161, for example, based on an ACK from the AP MLD 131, for example, to acknowledge the change of the power management mode for the second non-AP STA based on the third frame, e.g., as described below.

In some demonstrative aspects, device 102 and/or device 140 may be configured to perform one or more operations and/or functionalities of a multi-link power management mechanism, which may be configured to support a processing delay of an AP MLD, e.g., as described below.

In some demonstrative aspects, it may be defined that an AP MLD, e.g., AP MLD 131, is to announce a Cross Link Processing Delay (CLPD) value for cross link Power management (PM) mode change, e.g., as described below.

In some demonstrative aspects, it may be defined that the AP MLD, e.g., AP MLD 131, is to announce the CLPD value in as a capability of the AP MLD.

In some demonstrative aspects, it may be defined that the AP MLD, e.g., AP MLD 131, is to announce the CLPD value as part of a suitable capability element, capability field, or capability subfield, in one or more frames transmitted by the AP MLD.

In some demonstrative aspects, it may be defined that the AP MLD, e.g., AP MLD 131, is to announce the CLPD value, e.g., as a capability, in one or more management frames transmitted by the AP MLD.

In some demonstrative aspects, it may be defined that the AP MLD, e.g., AP MLD 131, is to announce the CLPD value in one or more broadcasted beacon frames broadcasted by the AP MLD.

In some demonstrative aspects, it may be defined that the AP MLD, e.g., AP MLD 131, is to announce the CLPD value in one or more broadcasted probe response frames broadcasted by the AP MLD.

In some demonstrative aspects, it may be defined that the AP MLD, e.g., AP MLD 131, is to announce the CLPD value in one or more unicast frames transmitted by the AP MLD.

In some demonstrative aspects, it may be defined that the AP MLD, e.g., AP MLD 131, is to announce the CLPD value in one or more unicast probe response frames transmitted from the AP MLD to a non-AP MLD, e.g., non-AP MLD 151.

In some demonstrative aspects, it may be defined that the AP MLD, e.g., AP MLD 131, is to announce the CLPD value in one or more unicast association response frames transmitted from the AP MLD to a non-AP MLD, e.g., non-AP MLD 151.

In some demonstrative aspects, it may be defined that the AP MLD, e.g., AP MLD 131, is to announce the CLPD value in one or more additional or alternative types of frames transmitted by the AP MLD.

In some demonstrative aspects, it may be defined that the CLPD value is to be based on, to indicate, and/or to represent a CLPD of the AP MLD, e.g., AP MLD 131, from which the CLPD value is transmitted.

In some demonstrative aspects, it may be defined that the CLPD of an AP MLD, e.g., AP MLD 131, may be the time interval between the time that the PM mode indication for another link is received by one AP of the AP MLD, for example, until the time that another AP of the same AP MLD on another link process the received PM indication.

In some demonstrative aspects, it may be defined that the CLPD of an AP MLD, e.g., AP MLD 131, may not be higher than a predefined maximal CLPD value, e.g., in units of milliseconds (ms).

In some demonstrative aspects, it may be defined that, for example, when enabling a cross link power save mode (also referred to as “multi-link power management mode”), for example, through negotiation, e.g., if the cross link power save mode is optional, or through an association process, e.g., if the cross link power save mode is mandatory, an AP MLD shall indicate a maximal processing delay of the AP MLD for the cross link power save mode.

In some demonstrative aspects, it may be defined that the AP MLD is to signal (indicate) the maximal processing delay of the AP MLD for the cross link power save mode, for example, using a predefined field (“processing delay field”), e.g., a new field, for example, a “Cross Link Power Save (PS) Processing Delay field”, a “multi-link processing delay subfield”, an “MLPM processing delay subfield”, or the like.

In some demonstrative aspects, it may be defined that the AP MLD is to set the predefined processing delay field to a value (“processing delay value”), e.g., a CLPD value, a multi-link processing delay value, an MLPM processing delay value, or the like, which may be based on, may indicate, and/may represent, the processing delay of the AP MLD for the cross link power save mode.

In some demonstrative aspects, it may be defined that the AP MLD is to include the predefined processing delay field in one or more frames transmitted by the AP MLD.

In some demonstrative aspects, it may be defined that the AP MLD is to include the predefined processing delay field in multi-link element in one or more frames transmitted by the AP MLD.

In some demonstrative aspects, it may be defined that the AP MLD is to include the predefined processing delay field in a common info field of the multi-link element.

In some demonstrative aspects, it may be defined that the AP MLD is to include the predefined processing delay field in a per-user info field of the multi-link element, for example, to support signaling of different processing delay values, e.g., for different pairs, e.g., for each pair, of affiliated links.

In other aspects, it may be defined that the AP MLD is to include the predefined processing delay field in one or more additional or alternative types of fields, elements and/or frames.

In some demonstrative aspects, a set of pre-known values for processing delay may be predefined, for example, according to a standard.

For example, a predefined mapping may be defined, for example, to map between a plurality of predefined processing delay values, e.g., multi-link processing delay values, and a respective plurality of predefined processing delay times, e.g., multi-link processing delay times.

In one example, a predefined table may be utilized to map between the plurality of predefined processing delay values, e.g., multi-link processing delay values, and the respective plurality of predefined processing delay times, e.g., multi-link processing delay times.

In some demonstrative aspects, it may be defend that an AP ML is to choose a selected processing delay value from the plurality of predefined processing delay values, for example, based on the actual processing delay of the AP MLD.

For example, it may be defend that an AP ML is to choose the selected processing delay value from the plurality of predefined processing delay values, for example, such that the selected processing delay value corresponds to a processing delay time, e.g., a shortest processing delay time, which is not shorter than the actual processing delay of the AP MLD.

In some demonstrative aspects, it may be defend that, for example, a non-AP STA (STA1) of a non-AP MLD may send on a link (link1) a cross link power save information signaling that another STA (STA2) of the non-AP MLD on another link (link2) is changing its power state/mode and will transition from an awake mode to a doze mode.

In some demonstrative aspects, it may be defined, for example, that for an AP MLD receiving the cross link power save information on the link1, an AP (AP2) of the AP MLD, which is associated with the STA2 over the link 2, will consider the STA2 to be in the doze mode, for example, a transition delay time after, e.g., only a transition delay time after, an acknowledgement is transmitted from an AP (AP) on the link1, e.g., to acknowledge the power management mode change of the STA2. The transition delay time may be based on, e.g., may be equal to, the processing delay time, e.g., the multi-link processing delay time, advertised by the AP MLD.

In some demonstrative aspects, it may be defined, for example, that the STA2 on link2 shall stay in the awake state, for example, until the time after the transition delay time, after which the STA2 may be able to transition to the doze state.

In some demonstrative aspects, it may be defined, for example, that in the time interval between a first time, e.g., the time STA1 indicated on link1 the power state change of STA2, and a second time, e.g., the time at which the power state change will take effect (after processing delay), the STA2 may send a frame on the link2 that may change the power state earlier.

In some demonstrative aspects, it may be defined, for example, that if there is a frame sent by the STA2 over the link2 in this time interval, then the power state change indication shall be the same as the one sent on the link1. For example, in case the power state change indication on the link1 indicates a transition from the awake state to the doze state, then the frame sent during the time interval from the STA2 shall also include a power state change from the awake state to the doze state.

In some demonstrative aspects, it may be defined, for example, that in case the frame is sent in the time interval over the link2, then the STA2 may go to the doze state, for example, right after receipt of an ACK of that frame, which may be received on link2 by the STA2. For example, the STA2 may be allowed to switch to the doze state, for example, without waiting for the end of the processing delay time interval.

In some demonstrative aspects, it may be defend that, for example, a non-AP STA (STA1) of a non-AP MLD may send on a link (link1) a cross link power save information signaling that another STA (STA2) of the non-AP MLD on another link (link2) is changing its power state/mode and will transition from doze mode to an awake mode.

In some demonstrative aspects, it may be defined, for example, that for an AP MLD receiving the cross link power save information on the link1, an AP (AP2) of the AP MLD, which is associated with the STA2 over the link 2, will consider the STA2 to be in the awake mode, for example, a transition delay time after, e.g., only a transition delay time after, an acknowledgement is transmitted from an AP (AP) on the link1, e.g., to acknowledge the power management mode change of the STA2. The transition delay time may be based on, e.g., may be equal to, the processing delay time, e.g., the multi-link processing delay time, advertised by the AP MLD.

In some demonstrative aspects, it may be defined, for example, that the STA2 on link2 may be allowed to transition directly to the awake state, and that, e.g., in case the STA2 would like to save extra power, the STA2 may be allowed to stay in the doze state, for example, until the time after the transition delay time expires, after which the STA2 shall transition to the awake state.

In some demonstrative aspects, it may be defined, for example, that in the time interval between a first time, e.g., the time STA1 indicated on link1 the power state change of STA2, and a second time, e.g., the time at which the power state change will take effect (after processing delay), the STA2 may send a frame on the link2 that may change the power state earlier.

In some demonstrative aspects, it may be defined, for example, that if there is a frame sent by the STA2 over the link2 in this time interval, then the power state change indication shall be the same as the one sent on the link1. For example, in case the power state change indication on the link1 indicates a transition from the doze state to the awake state, then the frame sent during the time interval from the STA2 shall also include a power state change from the doze state to the awake state.

In some demonstrative aspects, it may be defined, for example, that in case the frame is sent in the time interval over the link2, then the STA2 shall be in the awake state, for example, right after receipt of an ACK of that frame, which may be received on link2 by the STA2. For example, the STA2 may be allowed to switch to the awake state, for example, without waiting for the end of the processing delay time interval.

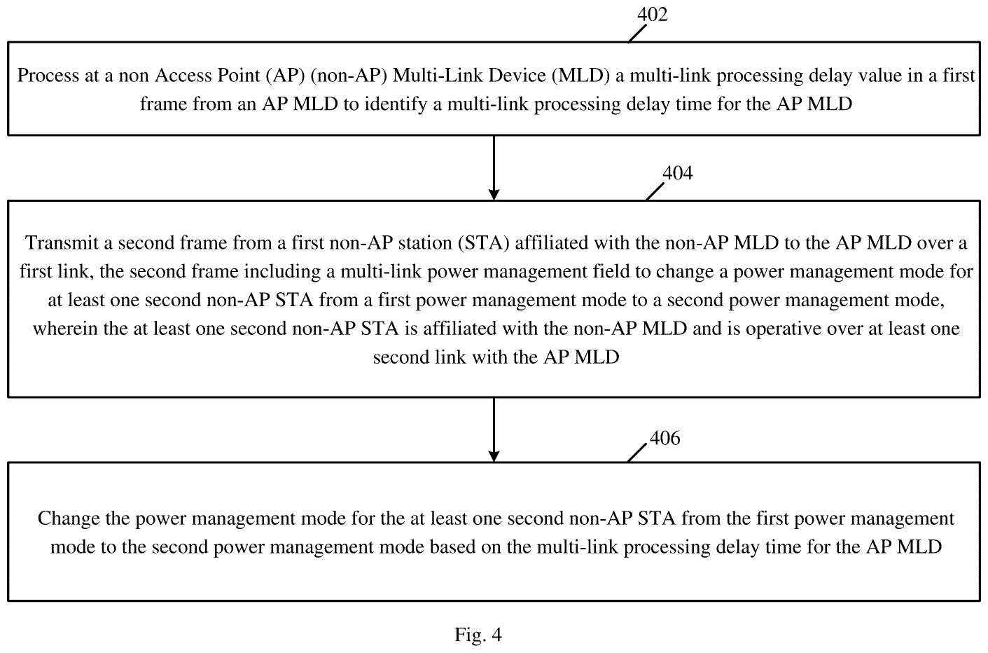

Reference is made to FIG. 4, which schematically illustrates a method of multi-link power management, in accordance with some demonstrative aspects. For example, one or more of the operations of the method of FIG. 4 may be performed by one or more elements of a system, e.g., system 100 (FIG. 1), for example, one or more wireless devices, e.g., device 102 (FIG. 1) and/or device 140 (FIG. 1), an MLD, e.g., MLD 131 (FIG. 1) and/or MLD 151 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 402, the method may include processing at a non-AP MLD a multi-link processing delay value in a first frame from an AP MLD to identify a multi-link processing delay time for the AP MLD. For example, controller 154 (FIG. 1) may be configured to cause, trigger, instruct, and/or control a non-AP MLD 151 (FIG. 1) implemented by device 102 (FIG. 1) to process the multi-link processing delay value in the first frame from the AP MLD 131 (FIG. 1) to identify a multi-link processing delay time for the AP MLD 131 (FIG. 1), e.g., as described above.

As indicated at block 404, the method may include transmitting a second frame from a first non-AP STA affiliated with the non-AP MLD to the AP MLD over a first link. For example, the second frame may include a multi-link power management field to change a power management mode for at least one second non-AP STA from a first power management mode to a second power management mode. For example, the at least one second non-AP STA may be affiliated with the non-AP MLD and may be operative over at least one second link with the AP MLD. For example, controller 154 (FIG. 1) may be configured to cause, trigger, instruct, and/or control the non-AP MLD 151 (FIG. 1) implemented by device 102 (FIG. 1) to transmit the second frame from the first non-AP STA 155 (FIG. 1) affiliated with the non-AP MLD 151 (FIG. 1) to the AP MLD 131 (FIG. 1) over the first link, e.g., as described above.

As indicated at block 406, the method may include changing the power management mode for the at least one second non-AP STA from the first power management mode to the second power management mode, for example, based on the multi-link processing delay time for the AP MLD. For example, controller 154 (FIG. 1) may be configured to cause, trigger, instruct, and/or control the non-AP MLD 151 (FIG. 1) implemented by device 102 (FIG. 1) to change the power management mode for the at least one second non-AP STA, e.g., STA 157 (FIG. 1), STA 159 (FIG. 1), and/or STA 161 (FIG. 1), from the first power management mode to the second power management mode, for example, based on the multi-link processing delay time for the AP MLD 131 (FIG. 1), e.g., as described above.

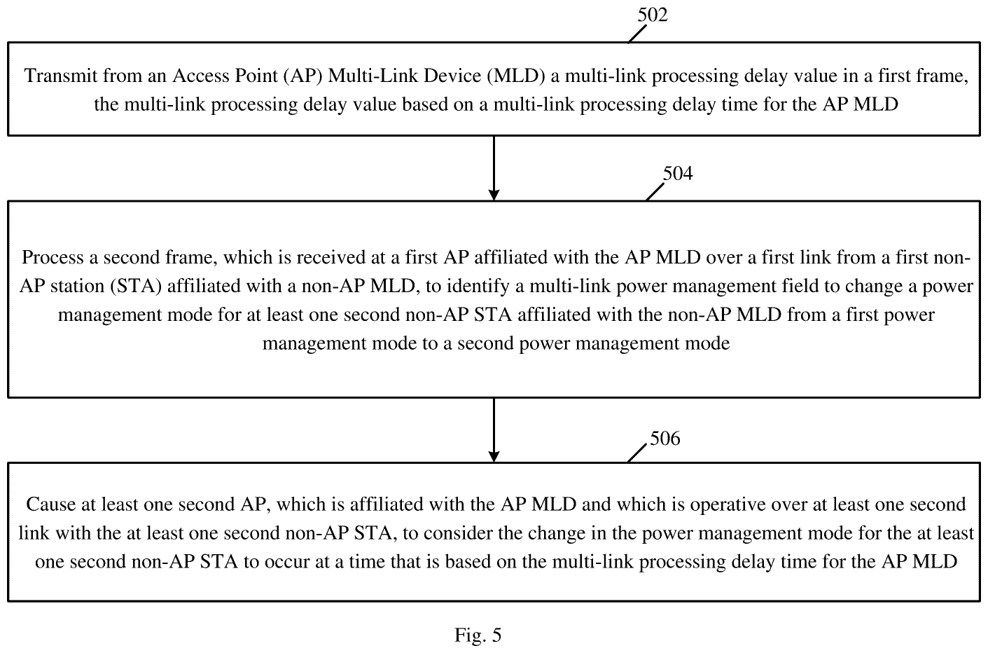

Reference is made to FIG. 5, which schematically illustrates a method of multi-link power management, in accordance with some demonstrative aspects. For example, one or more of the operations of the method of FIG. 5 may be performed by one or more elements of a system, e.g., system 100 (FIG. 1), for example, one or more wireless devices, e.g., device 102 (FIG. 1) and/or device 140 (FIG. 1), an MLD, e.g., MLD 131 (FIG. 1) and/or MLD 151 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 502, the method may include transmitting from an AP MLD a multi-link processing delay value in a first frame. For example, the multi-link processing delay value may be based on a multi-link processing delay time for the AP MLD. For example, controller 124 (FIG. 1) may be configured to cause, trigger, instruct, and/or control an AP MLD 131 (FIG. 1) implemented by device 102 (FIG. 1) to transmit the multi-link processing delay value in the first frame, e.g., as described above.

As indicated at block 504, the method may include processing a second frame, which is received at a first AP affiliated with the AP MLD over a first link from a first non-AP STA affiliated with a non-AP MLD, for example, to identify a multi-link power management field to change a power management mode for at least one second non-AP STA affiliated with the non-AP MLD from a first power management mode to a second power management mode. For example, controller 124 (FIG. 1) may be configured to cause, trigger, instruct, and/or control the AP MLD 131 (FIG. 1) implemented by device 102 (FIG. 1) to process the second frame, which is received at a first AP 135 (FIG. 1) affiliated with the AP MLD 131 (FIG. 1) over a first link from a first non-AP STA 155 (FIG. 1) affiliated with the non-AP MLD 151 (FIG. 1), for example, to identify a multi-link power management field to change a power management mode for at least one second non-AP STA, e.g., STA 157 (FIG. 1), Sta 159 (FIG. 1), and/or STA 161 (FIG. 1), affiliated with the non-AP MLD 131 (FIG. 1) from a first power management mode to a second power management mode, e.g., as described above.

As indicated at block 506, the method may include causing at least one second AP, which is affiliated with the AP MLD and which is operative over at least one second link with the at least one second non-AP STA, to consider the change in the power management mode for the at least one second non-AP STA to occur at a time that is based on the multi-link processing delay time for the AP MLD. For example, controller 124 (FIG. 1) may be configured to cause, trigger, instruct, and/or control the AP MLD 131 (FIG. 1) implemented by device 102 (FIG. 1) to cause at least one second AP, e.g., AP 137 (FIG. 1), AP 139 (FIG. 1), and/or AP 141 (FIG. 1), which is affiliated with the AP MLD 131 (FIG. 1) and which is operative over at least one second link with the at least one second non-AP STA, to consider the change in the power management mode for the at least one second non-AP STA to occur at a time that is based on the multi-link processing delay time for the AP MLD 131 (FIG. 1), e.g., as described above.

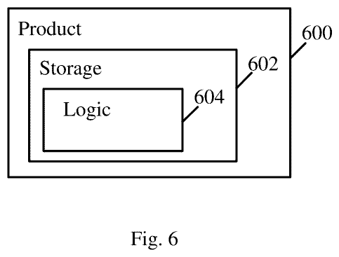

Reference is made to FIG. 6, which schematically illustrates a product of manufacture 600, in accordance with some demonstrative aspects. Product 600 may include one or more tangible computer-readable (“machine-readable”) non-transitory storage media 602, which may include computer-executable instructions, e.g., implemented by logic 604, operable to, when executed by at least one computer processor, enable the at least one computer processor to implement one or more operations at device 102 (FIG. 1), device 140 (FIG. 1), MLD 131 (FIG. 1), MLD 151 (FIG. 1), radio 114 (FIG. 1), radio 144 (FIG. 1), transmitter 118 (FIG. 1), transmitter 148 (FIG. 1), receiver 116 (FIG. 1), receiver 146 (FIG. 1), message processor 128 (FIG. 1), message processor 158 (FIG. 1), controller 124 (FIG. 1), and/or controller 154 (FIG. 1); to cause device 102 (FIG. 1), device 140 (FIG. 1), MLD 131 (FIG. 1), MLD 151 (FIG. 1), radio 114 (FIG. 1), radio 144 (FIG. 1), transmitter 118 (FIG. 1), transmitter 148 (FIG. 1), receiver 116 (FIG. 1), receiver 146 (FIG. 1), message processor 128 (FIG. 1), message processor 158 (FIG. 1), controller 124 (FIG. 1), and/or controller 154 (FIG. 1), to perform, trigger and/or implement one or more operations and/or functionalities; and/or to perform, trigger and/or implement one or more operations and/or functionalities described with reference to the FIGS. 1-5, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 600 and/or machine readable storage media 602 may include one or more types of computer-readable storage media capable of storing data, including volatile memory, non-volatile memory, removable or non-removable memory, erasable or non-erasable memory, writeable or re-writeable memory, and the like. For example, machine readable storage media 602 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 604 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 604 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising a processor configured to cause a non Access Point (AP) (non-AP) Multi-Link Device (MLD) to process a multi-link processing delay value in a first frame from an AP MLD to identify a multi-link processing delay time for the AP MLD; transmit a second frame from a first non-AP station (STA) affiliated with the non-AP MLD to the AP MLD over a first link, the second frame comprising a multi-link power management field to change a power management mode for at least one second non-AP STA from a first power management mode to a second power management mode, wherein the at least one second non-AP STA is affiliated with the non-AP MLD and is operative over at least one second link with the AP MLD; and change the power management mode for the at least one second non-AP STA from the first power management mode to the second power management mode based on the multi-link processing delay time for the AP MLD; and a memory to store information processed by the processor.

Example 2 includes the subject matter of Example 1, and optionally, wherein the apparatus is configured to cause the non-AP MLD to maintain the at least one second non-AP STA at the first power management mode during a delay time interval after the second frame, a duration of the delay time interval based on the multi-link processing delay time for the AP MLD.

Example 3 includes the subject matter of Example 2, and optionally, wherein the apparatus is configured to cause the non-AP MLD to determine a beginning of the delay time interval based on an Acknowledgement (ACK) from the AP MLD to acknowledge the change of the power management mode for the at least one second non-AP STA.

Example 4 includes the subject matter of Example 2 or 3, and optionally, wherein the apparatus is configured to cause the non-AP MLD to allow the at least one second non-AP STA to change from the first power management mode to the second power management mode after the delay time interval.

Example 5 includes the subject matter of any one of Examples 2-4, and optionally, wherein the duration of the delay time interval is equal to the multi-link processing delay time for the AP MLD.

Example 6 includes the subject matter of any one of Examples 1-5, and optionally, wherein the apparatus is configured to cause the non-AP MLD to allow the second non-AP STA to transmit a third frame to the AP MLD over the second link after the second frame and before a time for changing the power management mode for the second non-AP STA based on the multi-link processing delay time for the AP MLD, the third frame comprising the multi-link power management field to change the power management mode for the second non-AP STA.

Example 7 includes the subject matter of Example 6, and optionally, wherein the apparatus is configured to cause the non-AP MLD to change the power management mode of the second non-AP STA based on an Acknowledgement (ACK) from the AP MLD to acknowledge the change of the power management mode for the second non-AP STA based on the third frame.

Example 8 includes the subject matter of any one of Examples 1-7, and optionally, wherein the apparatus is configured to cause the non-AP MLD to determine the multi-link processing delay time for the AP MLD based on a predefined mapping between the multi-link processing delay value and a predefined multi-link processing delay time.

Example 9 includes the subject matter of any one of Examples 1-8, and optionally, wherein the apparatus is configured to cause the non-AP MLD to determine the multi-link processing delay time for the AP MLD based on a predefined mapping between a plurality of multi-link processing delay values and a respective plurality of predefined multi-link processing delay times.

Example 10 includes the subject matter of any one of Examples 1-9, and optionally, wherein the apparatus is configured to cause the non-AP MLD to determine the multi-link processing delay time for the AP MLD to be no more than a predefined maximal multi-link processing delay time.

Example 11 includes the subject matter of any one of Examples 1-10, and optionally, wherein the multi-link processing delay time for the AP MLD comprises a time interval between a first time and a second time, the first time based on a time at which the multi-link power management field to change the power management mode is received at a first AP affiliated with the AP MLD, the second time is based on a time at which the multi-link power management field to change the power management mode is processed at a second AP affiliated with the AP MLD.

Example 12 includes the subject matter of any one of Examples 1-11, and optionally, wherein the change of the power management mode for the at least one second non-AP STA comprises a change of a power state for the at least one second non-AP STA.

Example 13 includes the subject matter of any one of Example 12, and optionally, wherein the change of the power state for the at least one second non-AP STA comprises a change from an awake power state to a doze power state, or a change from the doze power state to the awake power state.

Example 14 includes the subject matter of any one of Examples 1-11, and optionally, wherein the change of the power management mode for the at least one second non-AP STA comprises a change of a power mode for the at least one second non-AP STA.

Example 15 includes the subject matter of any one of Example 14, and optionally, wherein the change of the power mode for the at least one second non-AP STA comprises a change from an active power mode to a power save mode, or a change from the power save mode to the active power mode.

Example 16 includes the subject matter of any one of Examples 1-15, and optionally, wherein the apparatus is configured to cause the non-AP MLD to identify the multi-link processing delay value in a multi-link processing delay subfield in the first frame, the multi-link processing delay subfield in a multi-link element of the first frame.

Example 17 includes the subject matter of Example 16, and optionally, wherein the apparatus is configured to cause the non-AP MLD to identify the multi-link processing delay subfield in a common information (info) field of the multi-link element.

Example 18 includes the subject matter of Example 16, and optionally, wherein the apparatus is configured to cause the non-AP MLD to identify the multi-link processing delay subfield in a per-user information (info) field of the multi-link element.

Example 19 includes the subject matter of any one of Examples 1-18, and optionally, wherein the apparatus is configured to cause the non-AP MLD to identify the multi-link processing delay value in a Cross Link Processing Delay (CLPD) subfield in the first frame.

Example 20 includes the subject matter of any one of Examples 1-19, and optionally, wherein the first frame comprises a management frame from the AP MLD.

Example 21 includes the subject matter of any one of Examples 1-20, and optionally, wherein the first frame comprises a broadcasted frame from the AP MLD.

Example 22 includes the subject matter of any one of Examples 1-21, and optionally, wherein the first frame comprises a broadcasted beacon frame from the AP MLD.

Example 23 includes the subject matter of any one of Examples 1-22, and optionally, wherein the first frame comprises a broadcast probe response frame from the AP MLD.

Example 24 includes the subject matter of any one of Examples 1-20, and optionally, wherein the first frame comprises a unicast frame from the AP MLD to the non-AP MLD.

Example 25 includes the subject matter of any one of Examples 1-20, and optionally, wherein the first frame comprises a unicast probe response frame from the AP MLD to the non-AP MLD.

Example 26 includes the subject matter of any one of Examples 1-20, and optionally, wherein the first frame comprises a unicast association response frame from the AP MLD to the non-AP MLD.

Example 27 includes the subject matter of any one of Examples 1-26, and optionally, wherein the non-AP MLD comprises a Multi-Link Power Management (MLPM) non-AP MLD.

Example 28 includes the subject matter of any one of Examples 1-27, and optionally, comprising at least one radio to communicate the first frame and the second frame.

Example 29 includes the subject matter of Example 28, and optionally, comprising one or more antennas connected to the at least one radio, and a processor to execute instructions of an operating system.

Example 30 includes an apparatus comprising a processor configured to cause an Access Point (AP) Multi-Link Device (MLD) to transmit a multi-link processing delay value in a first frame, the multi-link processing delay value based on a multi-link processing delay time for the AP MLD; process a second frame, which is received at a first AP affiliated with the AP MLD over a first link from a first non-AP station (STA) affiliated with a non-AP MLD, to identify a multi-link power management field to change a power management mode for at least one second non-AP STA affiliated with the non-AP MLD from a first power management mode to a second power management mode; and cause at least one second AP, which is affiliated with the AP MLD and which is operative over at least one second link with the at least one second non-AP STA, to consider the change in the power management mode for the at least one second non-AP STA to occur at a time that is based on the multi-link processing delay time for the AP MLD; and a memory to store information processed by the processor.

Example 31 includes the subject matter of Example 30, and optionally, wherein the apparatus is configured to cause the AP MLD to consider the at least one second non-AP STA to be at the first power management mode during a delay time interval after the second frame, a duration of the delay time interval based on the multi-link processing delay time for the AP MLD.

Example 32 includes the subject matter of Example 31, and optionally, wherein the apparatus is configured to cause the AP MLD to determine a beginning of the delay time interval based on an Acknowledgement (ACK) from the first AP to acknowledge the change of the power management mode for the at least one second non-AP STA.

Example 33 includes the subject matter of Example 31 or 32, and optionally, wherein the apparatus is configured to cause the AP MLD to consider the at least one second non-AP STA to be at the second power management mode after the delay time interval.

Example 34 includes the subject matter of any one of Examples 31-33, and optionally, wherein the duration of the delay time interval is equal to the multi-link processing delay time for the AP MLD.

Example 35 includes the subject matter of any one of Examples 30-34, and optionally, wherein the apparatus is configured to cause the AP MLD to:
process a third frame received from the second non-AP STA at the second AP over the second link after the second frame and before the time based on the multi-link processing delay time for the AP MLD, the third frame comprising the multi-link power management field to change the power management mode for the second non-AP STA; and
transmit an Acknowledgement (ACK) from the second AP to acknowledge the change of the power management mode for the second non-AP STA based on the third frame.

Example 36 includes the subject matter of any one of Examples 30-35, and optionally, wherein the apparatus is configured to cause the AP MLD to set the multi-link processing delay value in the first frame based on a predefined mapping between the multi-link processing delay value and a predefined multi-link processing delay time.

Example 37 includes the subject matter of any one of Examples 30-36, and optionally, wherein the apparatus is configured to cause the AP MLD to set the multi-link processing delay value in the first frame based on a predefined mapping between a plurality of multi-link processing delay values and a respective plurality of predefined multi-link processing delay times.

Example 38 includes the subject matter of any one of Examples 30-37, and optionally, wherein the apparatus is configured to cause the AP MLD to determine the multi-link processing delay time for the AP MLD to be no more than a predefined maximal multi-link processing delay time.

Example 39 includes the subject matter of any one of Examples 30-38, and optionally, wherein the multi-link processing delay time for the AP MLD comprises a time interval between a first time and a second time, the first time based on a time at which the multi-link power management field to change the power management mode is received at the first AP, the second time is based on a time at which the multi-link power management field to change the power management mode is processed at the at least one second AP.

Example 40 includes the subject matter of any one of Examples 30-39, and optionally, wherein the change of the power management mode for the at least one second non-AP STA comprises a change of a power state for the at least one second non-AP STA.

Example 41 includes the subject matter of any one of Example 40, and optionally, wherein the change of the power state for the at least one second non-AP STA comprises a change from an awake power state to a doze power state, or a change from the doze power state to the awake power state.

Example 42 includes the subject matter of any one of Examples 30-39, and optionally, wherein the change of the power management mode for the at least one second non-AP STA comprises a change of a power mode for the at least one second non-AP STA.

Example 43 includes the subject matter of any one of Example 42, and optionally, wherein the change of the power mode for the at least one second non-AP STA comprises a change from an active power mode to a power save mode, or a change from the power save mode to the active power mode.

Example 44 includes the subject matter of any one of Examples 30-43, and optionally, wherein the apparatus is configured to cause the AP MLD to set the multi-link processing delay value in a multi-link processing delay subfield in the first frame, the multi-link processing delay subfield in a multi-link element of the first frame.

Example 45 includes the subject matter of Example 44, and optionally, wherein the apparatus is configured to cause the AP MLD to set the multi-link processing delay subfield in a common information (info) field of the multi-link element.

Example 46 includes the subject matter of Example 44, and optionally, wherein the apparatus is configured to cause the AP MLD to set the multi-link processing delay subfield in a per-user information (info) field of the multi-link element.

Example 47 includes the subject matter of any one of Examples 30-46, and optionally, wherein the apparatus is configured to cause the AP MLD to set the multi-link processing delay value in a Cross Link Processing Delay (CLPD) subfield in the first frame.

Example 48 includes the subject matter of any one of Examples 30-47, and optionally, wherein the first frame comprises a management frame from the AP MLD.

Example 49 includes the subject matter of any one of Examples 30-48, and optionally, wherein the first frame comprises a broadcasted frame from the AP MLD.

Example 50 includes the subject matter of any one of Examples 30-49, and optionally, wherein the first frame comprises a broadcasted beacon frame from the AP MLD.

Example 51 includes the subject matter of any one of Examples 30-50, and optionally, wherein the first frame comprises a broadcast probe response frame from the AP MLD.

Example 52 includes the subject matter of any one of Examples 30-48, and optionally, wherein the first frame comprises a unicast frame from the AP MLD to the non-AP MLD.

Example 53 includes the subject matter of any one of Examples 30-48, and optionally, wherein the first frame comprises a unicast probe response frame from the AP MLD to the non-AP MLD.

Example 54 includes the subject matter of any one of Examples 30-48, and optionally, wherein the first frame comprises a unicast association response frame from the AP MLD to the non-AP MLD.

Example 55 includes the subject matter of any one of Examples 30-54, and optionally, wherein the AP MLD comprises a Multi-Link Power Management (MLPM) AP MLD.

Example 56 includes the subject matter of any one of Examples 30-55, and optionally, comprising at least one radio to communicate the first frame and the second frame.

Example 57 includes the subject matter of Example 56, and optionally, comprising one or more antennas connected to the at least one radio, and a processor to execute instructions of an operating system.

Example 58 includes a wireless communication device comprising the apparatus of any of Examples 1-57.

Example 59 includes a mobile device comprising the apparatus of any of Examples 1-57.

Example 60 includes an apparatus comprising means for executing any of the described operations of any of Examples 1-57.

Example 61 includes a product comprising one or more tangible computer-readable non-transitory storage media comprising instructions operable to, when executed by at least one processor, enable the at least one processor to cause a wireless communication device to perform any of the described operations of any of Examples 1-57.

Example 62 includes an apparatus comprising: a memory interface; and processing circuitry configured to: perform any of the described operations of any of Examples 1-57.

Example 63 includes a method comprising any of the described operations of any of Examples 1-57.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising:
a processor configured to cause a non Access Point (AP) (non-AP) Multi-Link Device (MLD) to:
process a multi-link processing delay value in a first frame from an AP MLD to identify a multi-link processing delay time for the AP MLD;
transmit a second frame from a first non-AP station (STA) affiliated with the non-AP MLD to the AP MLD over a first link, the second frame comprising a multi-link power management field to change a power management mode for at least one second non-AP STA from a first power management mode to a second power management mode, wherein the at least one second non-AP STA is affiliated with the non-AP MLD and is operative over at least one second link with the AP MLD; and
change the power management mode for the at least one second non-AP STA from the first power management mode to the second power management mode based on the multi-link processing delay time for the AP MLD; and
a memory to store information processed by the processor.

2. The apparatus of claim 1 configured to cause the non-AP MLD to maintain the at least one second non-AP STA at the first power management mode during a delay time interval after the second frame, a duration of the delay time interval based on the multi-link processing delay time for the AP MLD.

3. The apparatus of claim 2 configured to cause the non-AP MLD to determine a beginning of the delay time interval based on an Acknowledgement (ACK) from the AP MLD to acknowledge the change of the power management mode for the at least one second non-AP STA.

4. The apparatus of claim 2 configured to cause the non-AP MLD to allow the at least one second non-AP STA to change from the first power management mode to the second power management mode after the delay time interval.

5. The apparatus of claim 2, wherein the duration of the delay time interval is equal to the multi-link processing delay time for the AP MLD.

6. The apparatus of claim 1 configured to cause the non-AP MLD to allow the second non-AP STA to transmit a third frame to the AP MLD over the second link after the second frame and before a time for changing the power management mode for the second non-AP STA based on the multi-link processing delay time for the AP MLD, the third frame comprising the multi-link power management field to change the power management mode for the second non-AP STA.

7. The apparatus of claim 6 configured to cause the non-AP MLD to change the power management mode of the second non-AP STA based on an Acknowledgement (ACK) from the AP MLD to acknowledge the change of the power management mode for the second non-AP STA based on the third frame.

8. The apparatus of claim 1 configured to cause the non-AP MLD to determine the multi-link processing delay time for the AP MLD based on a predefined mapping between the multi-link processing delay value and a predefined multi-link processing delay time.

9. The apparatus of claim 1 configured to cause the non-AP MLD to determine the multi-link processing delay time for the AP MLD based on a predefined mapping between a plurality of multi-link processing delay values and a respective plurality of predefined multi-link processing delay times.

10. The apparatus of claim 1 configured to cause the non-AP MLD to determine the multi-link processing delay time for the AP MLD to be no more than a predefined maximal multi-link processing delay time.

11. The apparatus of claim 1, wherein the multi-link processing delay time for the AP MLD comprises a time interval between a first time and a second time, the first time based on a time at which the multi-link power management field to change the power management mode is received at a first AP affiliated with the AP MLD, the second time is based on a time at which the multi-link power management field to change the power management mode is processed at a second AP affiliated with the AP MLD.

12. The apparatus of claim 1, wherein the change of the power management mode for the at least one second non-AP STA comprises a change of a power state for the at least one second non-AP STA.

13. The apparatus of claim 1, wherein the change of the power management mode for the at least one second non-AP STA comprises a change of a power mode for the at least one second non-AP STA.

14. The apparatus of claim 1 configured to cause the non-AP MLD to identify the multi-link processing delay value in a multi-link processing delay subfield in the first frame, the multi-link processing delay subfield in a multi-link element of the first frame.

15. The apparatus of claim 1, wherein the first frame comprises a management frame from the AP MLD.

16. The apparatus of claim 1 comprising at least one radio to communicate the first frame and the second frame.

17. The apparatus of claim 16 comprising one or more antennas connected to the at least one radio, and another processor to execute instructions of an operating system.

18. A product comprising one or more tangible computer-readable non-transitory storage media comprising instructions operable to, when executed by at least one processor, enable the at least one processor cause a non Access Point (AP) (non-AP) Multi-Link Device (MLD) to:
process a multi-link processing delay value in a first frame from an AP MLD to identify a multi-link processing delay time for the AP MLD;
transmit a second frame from a first non-AP station (STA) affiliated with the non-AP MLD to the AP MLD over a first link, the second frame comprising a multi-link power management field to change a power management mode for at least one second non-AP STA from a first power management mode to a second power management mode, wherein the at least one second non-AP STA is affiliated with the non-AP MLD and is operative over at least one second link with the AP MLD; and
change the power management mode for the at least one second non-AP STA from the first power management mode to the second power management mode based on the multi-link processing delay time for the AP MLD.

19. The product of claim 18, wherein the instructions, when executed, cause the non-AP MLD to maintain the at least one second non-AP STA at the first power management mode during a delay time interval after the second frame, a duration of the delay time interval based on the multi-link processing delay time for the AP MLD.

20. The product of claim 18, wherein the instructions, when executed, cause the non-AP MLD to transmit a third frame to the AP MLD over the second link after the second frame and before a time for changing the power management mode for the second non-AP STA based on the multi-link processing delay time for the AP MLD, the third frame comprising the multi-link power management field to change the power management mode for the second non-AP STA.
